(19) United States
(12) Patent Application Publication
(10) Pub. No.: US 2025/0367807 A1
(43) Pub. Date: Dec. 4, 2025

(54) Multi-Column Clamping Arrangement for a Power Tool

(71) Applicant: Robert Bosch GmbH, Stuttgart (DE)

(72) Inventors: Peter Jack Wierzchon, Morton Grove, IL (US); Gregory J. Spiewak, Coal City, IL (US)

(21) Appl. No.: 18/675,705

(22) Filed: May 28, 2024

(51) Int. Cl. B25F 5/00; B27C 5/10

(52) U.S. Cl. CPC B25F 5/003; B27C 5/10

(57) ABSTRACT

A power tool includes at least two columns, a carriage configured to move along the at least two columns, and a clamping arrangement configured to selectively clamp the carriage to at least a first column and a second column of the at least two columns. The clamping arrangement has an actuator configured to be actuated to move the clamping arrangement between a clamped state and an unclamped state, and a force redirecting member. In the clamped state, the actuator acts on the force redirecting member with an actuator force in a first direction, and the force redirecting member redirects the actuator force into a first clamping force acting on the first column in a second direction and a second clamping force acting on the second column in a third direction.

### FIELD

This disclosure relates generally to clamping arrangements for a power tool, and, more particularly, clamping arrangements for clamping to multiple columns.

### BACKGROUND

Certain power tools such as routers, router lifts, sliding miter saws, and larger planers utilize two or more axial columns to allow the motor carriage or cutting mechanism to translate in the axial direction. In the case of a plunge router, for example, the translation along the axial direction allows the router bit to engage and disengage the workpiece. Once the cutting depth in the workpiece is reached, the motor carriage is secured from movement along the column length so as to fix the height of the router bit relative to the workpiece. It is desirable for the router height lock to be stable and not allow movement or deflection of the router bit, as such movement or deflection can affect the quality of the cut in the workpiece, potentially ruining the workpiece entirely. Further, excessive movement of the router bit can be a safety concern for the user of the router.

One conventional approach to locking the motor carriage has been to use a single screw that is threaded into a hole and impinges upon the column to apply a locking load to a single one of the columns. However, because such a column lock only engages a single one of the columns, the required clearances in the bushing, column, and other machined parts allows for some axial movement on the non-locking column axis. As a result, the bit may move slightly relative to the workpiece, reducing the quality of the subsequent machining processes.

In another conventional solution, an externally rotatable threaded rod runs past and engages one column and impinges on the other column. In such an arrangement, however, the position of the locking mechanism actuated by the user can only be located adjacent to the line connecting the two columns. Further, the arrangement results in an awkward user interface since the position of the actuation mechanism requires the actuation mechanism to double as one of the router grips, which renders the hand grip asymmetrical. Moreover, the requirement that the threaded rod runs from one column to the other produces a packaging conflict with the motor, as the motor must be positioned within the housing so as to not interfere with the threaded rod.

Another solution to the aforementioned problems is a similar locking arrangement in which a rotatable threaded rod runs past and engages one column and impinges on the other column, but a gear set and bearings allows the user actuation element to be moved to a different position. Such a configuration, however, requires the added manufacturing complexity and tolerance requirements of a gear set and bearings, and further, suffers from the same deficiencies noted above with regard to the motor placement.

What is needed, therefore, is a locking arrangement that enables a secure locking connection to two or more columns, while allowing for enhanced ergonomics of the handles and locking actuator for the user. In addition, a locking arrangement that does not interfere with the motor would be beneficial as well.

### SUMMARY

In one embodiment, a power tool includes at least two columns, a carriage configured to move along the at least two columns, and a clamping arrangement configured to selectively clamp the carriage to at least a first column and a second column of the at least two columns. The clamping arrangement has an actuator configured to be actuated to move the clamping arrangement between a clamped state and an unclamped state, and a force redirecting member. In the clamped state, the actuator acts on the force redirecting member with an actuator force in a first direction, and the force redirecting member redirects the actuator force into a first clamping force acting on the first column in a second direction and a second clamping force acting on the second column in a third direction.

In another embodiment, a clamping arrangement includes an actuator configured to be actuated to move the clamping arrangement between a clamped state, in which the clamping arrangement clamps to at least a first column and a second column, and an unclamped state. The clamping arrangement further includes a force redirecting member. In the clamped state, the actuator acts on the force redirecting member with an actuator force in a first direction, and the force redirecting member redirects the actuator force into a first clamping force acting on the first column in a second direction and a second clamping force acting on the second column in a third direction.

### BRIEF DESCRIPTION OF THE DRAWINGS

FIG. 1 is top cross-sectional view of a router with a clamping arrangement according to the disclosure.

FIG. 2 is a detail view of the clamping arrangement of FIG. 1.

FIG. 3 is a schematic force diagram of the clamping arrangement of FIG. 1.

FIG. 4 is a top cross-sectional view of the router of FIG. 1 in which the clamping arrangement is offset from the center of the tool.

FIG. 5 is a detail view of the clamping arrangement of FIG. 4 in the unclamped state.

FIG. 6 is a detail view of the clamping arrangement of FIG. 5 in the clamped state.

FIG. 7 is a top cross-sectional view of a router with a clamping arrangement according to the disclosure in which one of the force transfer members is formed as a curved elongated member.

FIG. 8 is a top perspective view of the router of FIG. 7 showing the clamping arrangement being curved around the motor.

FIG. 9 is a rear perspective view of the router of FIG. 7, with the carriage not depicted for clarity of the components of the clamping arrangement.

FIG. 10 is a top view of the clamping arrangement of FIG. 7.

FIG. 11 is a top detail view of the clamping arrangement of FIG. 7.

FIG. 12 is a front perspective view of a router carriage and clamping arrangement according to another embodiment of the disclosure.

FIG. 13 is a top plan view of the router carriage and clamping arrangement of FIG. 12.

FIG. 14 is a top cross-sectional view of a router with a clamping arrangement according to the disclosure in which one the force transfer members are formed as linkages connected by a pin.

FIG. 15 is a detail view of the clamping arrangement of FIG. 14.

FIG. 16 is a top schematic view of a clamping arrangement according to the disclosure that clamps to four columns.

FIG. 17 is a perspective view of a router lift with a clamping arrangement according to the disclosure in which the actuator axis and the clamping plane are perpendicular to one another.

FIG. 18 is a side perspective view of a sliding saw with a clamping arrangement according to the disclosure.

### DETAILED DESCRIPTION

For the purposes of promoting an understanding of the principles of the embodiments described herein, reference is now made to the drawings and descriptions in the following written specification. No limitation to the scope of the subject matter is intended by the references. This disclosure also includes any alterations and modifications to the illustrated embodiments and includes further applications of the principles of the described embodiments as would normally occur to one skilled in the art to which this document pertains.

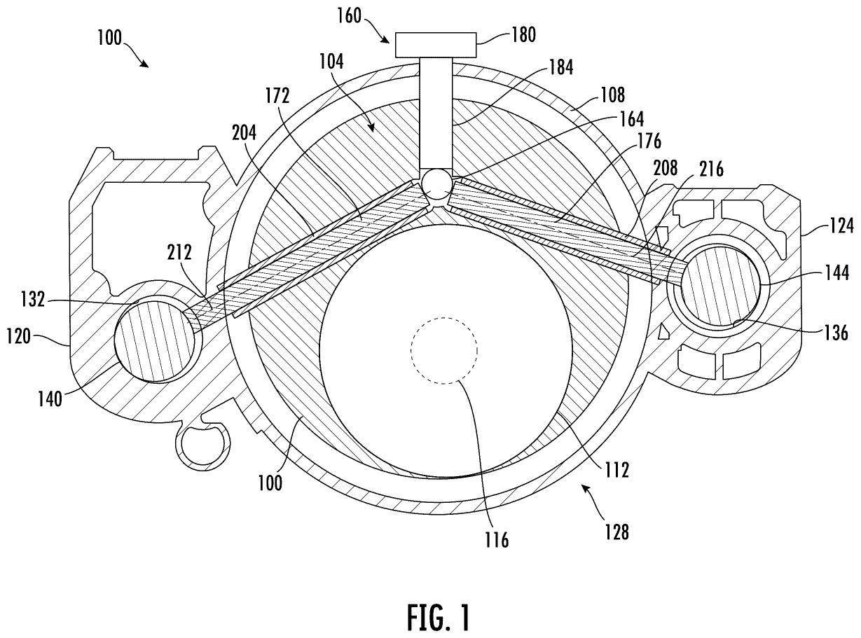

FIG. 1 depicts a cross-sectional view of a power tool 100, which is configured for example as a router, having a dual column clamping arrangement 104 according to the disclosure. The power tool 100 has a motor carriage 108, on which a motor 112 is supported. The motor 112 is operably connected to a bit holder 116, which receives a working tool, for example a router bit, a drill bit, a milling tool, or the like. The motor 112 drives the bit holder 116 to rotate the working tool so as to process material on a workpiece.

The motor carriage 108 has two lateral extensions 120, 124, to which grip handles (not shown in FIG. 1) are attached, arranged on opposite sides of a central region 128 in which the motor 112 is arranged. Each lateral extension 120, 124 defines a hollow cylinder 132, 136, in which a respective column 140, 144 is arranged with sufficient clearance to enable the motor carriage 108 to move along the axial direction of the columns 140, 144 (i.e. into and out from the view of FIG. 1) so as to set the depth of the working tool in the bit holder 116 to the desired cutting depth.

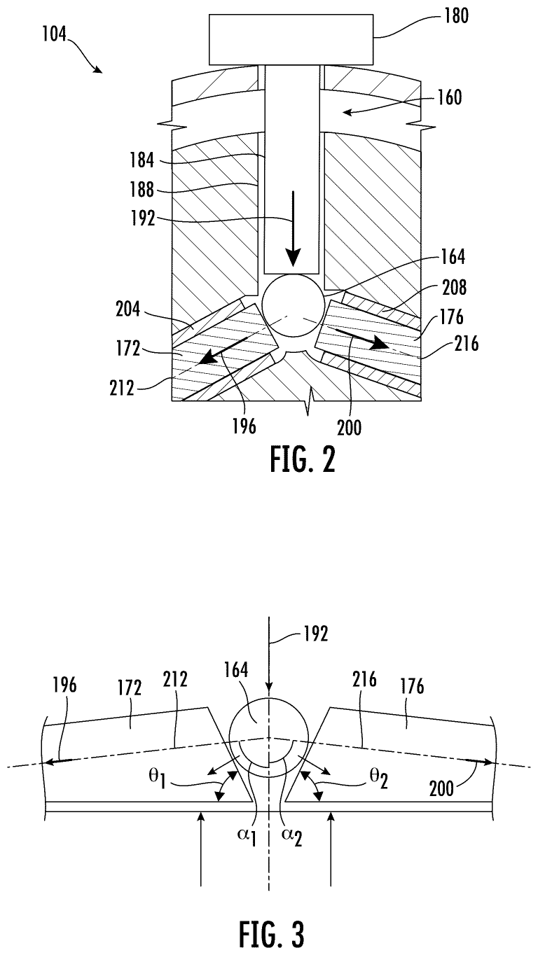

With reference now to FIG. 2 and continuing reference to FIG. 1, the clamping arrangement 104 includes an actuator 160, a force redirecting member 164, and two force transfer members 172, 176. In the illustrated embodiment, the actuator 160 is formed as manually manipulatable knob 180 attached to a threaded bolt 184 that is threaded into a threaded hole 188 of the motor carriage 108. In other embodiments the actuator 160 may be a thumbscrew, a lever connected to a threaded rod, a button, a cable, a linkage, a tapered wedge, a cam lever, a hydraulic actuator, or another suitable actuator. The actuator 160 is configured to selectively apply an actuator force 192 to the force redirecting member 164. More specifically, in the clamped state, the actuator 160 applies the actuator force 192 to the force redirecting member 164 and in the unclamped state, the actuator force 192 is reduced or eliminated.

The force redirecting member 164 is configured to redirect the actuator force 192 applied by the actuator 160 and apply clamping forces 196, 200 along the axes of the respective force transfer members 172, 176. In the illustrated embodiment, the force redirecting member 164 is a sphere, a disk, or a cylinder, though in other embodiments the force transfer member may be formed as an ellipsoid, an elliptical prism, a partial sphere or cylinder, a sphere or cylinder having one or more flattened surfaces, or any other shape that is suitable for receiving the actuator force 192 and redirecting it along the intersecting points of tangency to the force transfer members 172, 176 as the clamping forces 196 and 200.

Referring back to FIG. 1, each of the force transfer members 172, 176 extends from the

force redirecting member 164 to a respective one of the columns 140, 144. Each force transfer member 172, 176 may be arranged inside a linear bearing or support 204, 208 to facilitate axial movement of the force transfer members 172, 176. In the clamped state, the actuator force 192 applied by the actuator 160 is redirected to the force transfer members 172, 176 as clamping forces 196, 200, respectively. The force transfer members 172, 176 impinge on the respective columns 140, 144 such that the clamping forces 196, 200 acting along the axes 212, 216 of the force transfer members 172, 176 cause the force transfer members 172, 176 to clamp the respective column 140, 144 against the side of its associated cylinder 132, 136. As a result, both columns 140, 144 are immobilized in their associated cylinder 132, 136 to securely fix the carriage 108 relative to both columns 140, 144.

In the illustrated embodiment, the longitudinal axis of the actuator 160 is in substantially the same plane as the axes 212, 216 of the force transfer members 172, 176, which are generally perpendicular to the longitudinal axes of the columns 140, 144. In other embodiments, the actuator 160 and/or at least one of the force transfer members 172, 176 may be outside of the plane that is perpendicular to the longitudinal axes of the columns 140, 144.

Advantageously, the clamping arrangement 104 may be positioned in the front of the tool 100, where the actuator 160 is easily accessible to the operator of the tool 100. Additionally, since the two force transfer members 172, 176 are both angled away from their respective column 140, 144, the clamping arrangement 104 advantageously allows for a larger motor 112 without interfering with the motor 112 or requiring a complex arrangement to redirect the clamping arrangement around the motor 112.

Moreover, the disclosed clamping arrangement 104 is simple to manufacture and allows for relatively high tolerances to produce the desired clamping force on both columns 140, 144. Specifically, in embodiments using a ball or cylinder as the force redirecting member 164, the force redirecting member 164 maintains three points of contact: one with the actuator 160 and, more specifically, the end surface of the threaded rod 184, and one with each of the two force transfer members 172, 176, and more specifically, the end surfaces thereof. The ball or cylinder is movable to accommodate any tolerances between the component and to maintain a strong force redirecting function even with wear on the ball or the end surfaces.

Additionally, the disclosed clamping arrangement 104 is configured such that the actuator force 192 is redirected from a first direction into the clamping forces 196, 200 acting in two different directions. Because of this, the disclosed clamping arrangement 104 allows for the required actuator input force 192, the clamping forces 196, 200 acting on the columns 140, 144, and the associated mechanical advantage of the clamping arrangement 104 to be tuned by modifying the geometry of the structures in the clamping arrangement 104.

As shown in FIG. 3, the actuator force 192 is redirected along the surface normals of the

force redirecting member 164 at the points of intersection with the force redirecting members 172, 176. Since the force redirecting members are supported in the direction of the actuator force 192, the effective clamping forces 196, 200 act directly along the respective axes 212, 216 of the force transfer members 172, 176. The strengths of the clamping forces 196, 200 can therefore be tuned by varying the actuator force 192, the respective angles α₁, α₂ between the line of action of the actuator force 192 and the clamping forces 196, 200, and/or the angle θ₁, θ₂ of the end surfaces between the force redirecting member 164 and the force transfer members 172, 176. Put another way, the amount of actuator force 192 needed for a given clamping force 196, 200 can be adjusted by decreasing the angles α₁, α₂ between the lines of action of the forces or by decreasing the end surface angles θ₁, θ₂.

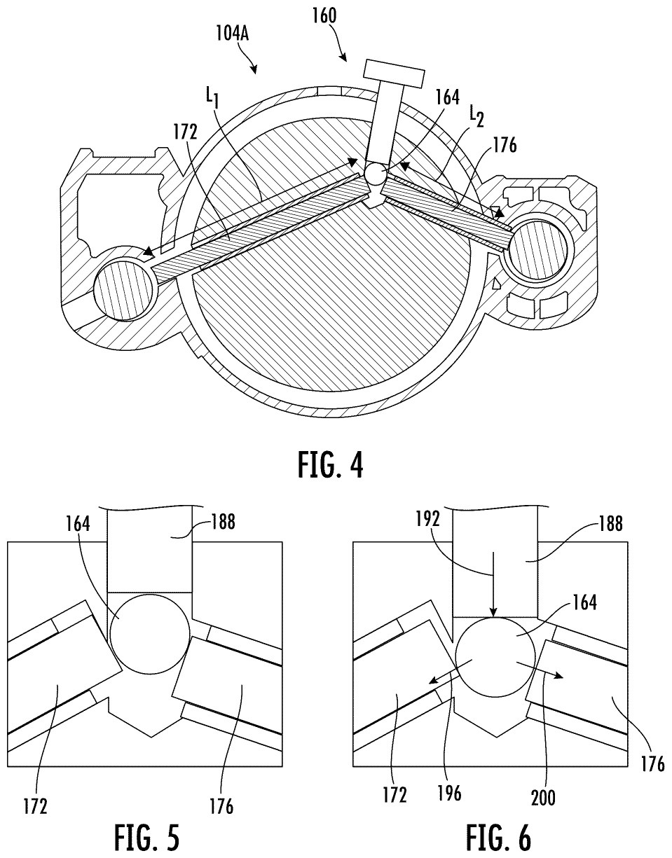

In addition, the lengths and positions of the force transfer members 172, 176 can be modified to adjust the forces and overall geometry of the clamping arrangement. For example, as seen in FIGS. 4-6, a clamping arrangement 104A is provided in which the lengths L₁, L₂ of the force transfer members 172, 176 are different and the actuator 160 is offset. More specifically, in the embodiment depicted in FIG. 4, the length L₁ of the force transfer member 172 is greater than the length L₂ of the force transfer member 172. As is best seen in FIGS. 5 and 6, even with the offset of the force transfer members 172, 176 and the actuator 160, the force redirecting member 164 can still move from the unclamped state (FIG. 5) to the clamped state (FIG. 6) while maintaining contact with the force transfer members 172, 176. As a result, the clamping arrangements disclosed herein allow for the actuator 160 to be moved to an ergonomically efficient position while still providing strong clamping on both columns.

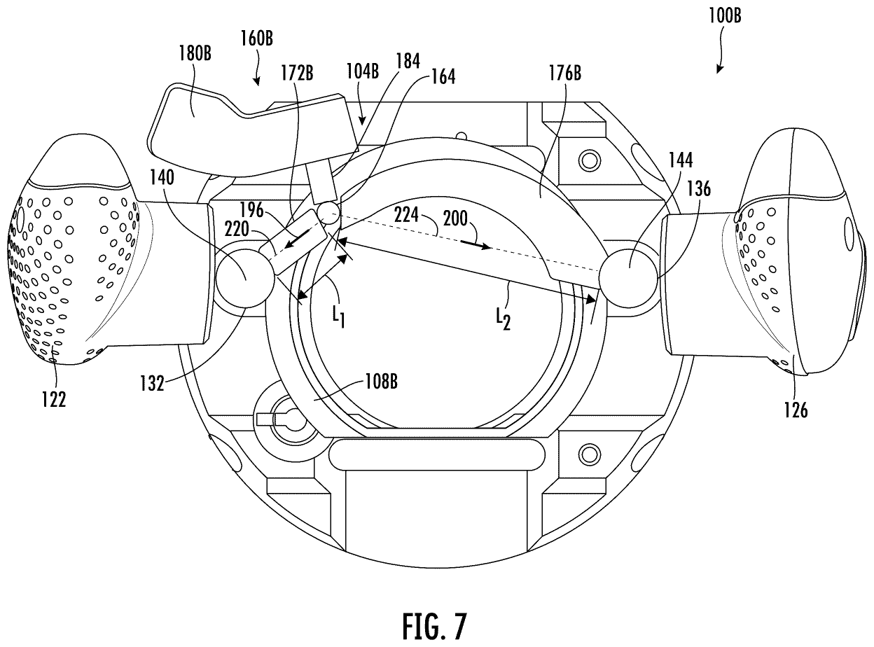

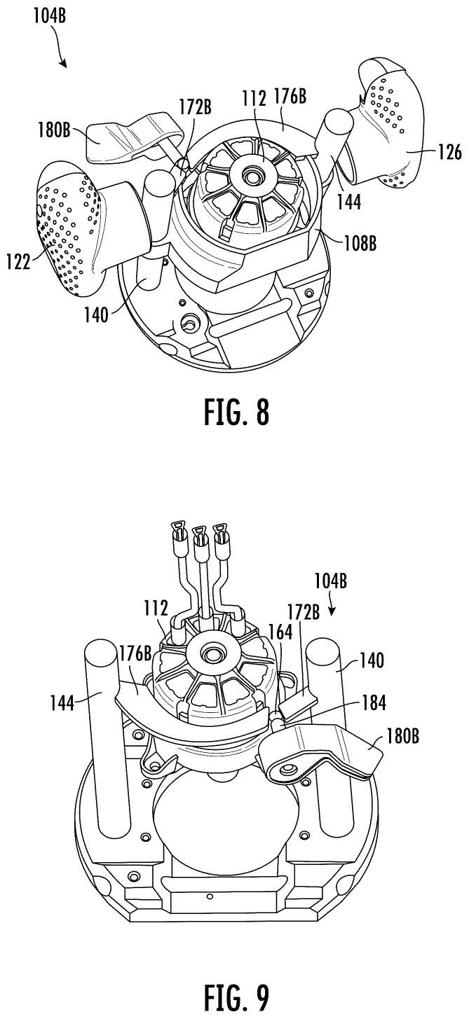

In addition, the force transfer members need not be straight rods to effectively transfer the forces in the disclosed clamping arrangements. For instance, FIGS. 7-11 depict an embodiment of a power tool 100B with a clamping arrangement 104B in which the actuator 160 is arranged on one side of the motor carriage 108 with one force transfer member 176B significantly longer than the other force transfer member 172B and in which the longer force transfer member 176B is curved. In such a configuration, advantageously, the clamping arrangement 104B may be designed to avoid interference with the motor 112, which is partially arranged in the line of action 224 of the clamping force 200 between the force redirecting member 164 and the column 144.

As seen in FIG. 7, the actuator 160B of the clamping arrangement 104B is configured as a lever 180B connected to a threaded rod 184. The lever 180B is, in particular, arranged adjacent to the grip region 122 such that, when using holding the tool 100B by the grip regions 122, 126 in the normal use of the tool 100B, the user's thumb is arranged adjacent to the lever 180B. As a result, the user can easily actuate the lever 180B without removing his or her hand from the grip region 122. Specifically, the lever 180B may be arranged at a distance of between approximately 0.25 inches and approximately 3 inches from the grip region 122. In another embodiment, the lever 180B may be arranged at a distance of between approximately 1 inch and approximately 2 inches from the grip region 122.

The force transfer member 176B is formed as an elongated curved member having a generally rectangular cross-section, though the reader should appreciate that the cross-section of the elongated curved member may be different in other embodiments. The force transfer member 176B may be, for example, accommodated in a complementary elongated curved channel 174B (FIG. 11) defined by the motor carriage 108B. The channel 174B constrains the force transfer member 176B such that there is minimal or no deflection of the force transfer member 176B due to bending loads of the clamping force 200, and the clamping force 200 is transferred by the force transfer member 176B from the force redirecting member 164 to the column 144. Thus, the functional load path of the clamping force 200 acts along the line of action 224 between the force redirecting member 164 and the column 144.

Since the actuator 160 is arranged adjacent to the handle 124, the force transfer member 172B is significantly shorter than the force transfer member 176B. For example, in one embodiment, the effective length L₂ of the force transfer member 176B, i.e. the length as measured along the straight-line from the force redirecting member 164 to the column 144, is more than three (3) times the effective length L₁ of the force transfer member 172B. In other embodiments, the ratio between L₁ and L₂ may be between approximately 4 and approximately 25, between approximately 5 and approximately 15, or between approximately 6 and approximately 12. In another embodiment, the shorter force transfer member 172B is omitted, such that the force redirecting member 164 acts directly on the column 140.

Additionally, the force transfer members 172B, 176B are configured such that the reaction forces 228, 232 acting on the two force transfer members 172B, 176B act in opposite directions on the associated force transfer member 172B, 176B. More specifically, in the illustrated embodiment, the angle of the end surface of the force transfer member 176B causes the force redirecting member 164 to exert a force component in the direction essentially toward the threaded rod 184, and the reaction force 228 acting on the force transfer member 172B therefore acts in a direction that is similar to the direction of the actuator force 192.

The curved configuration of the force transfer member 176B provides packaging advantages in the design of the power tool 100. In particular, the force transfer member 176B provides a simple and effective way to route the clamping force 200 around the motor 112. As a result, the motor 112 can be larger than conventional tools without requiring a complex arrangement to move the components of the clamping out of the plane of the motor 112.

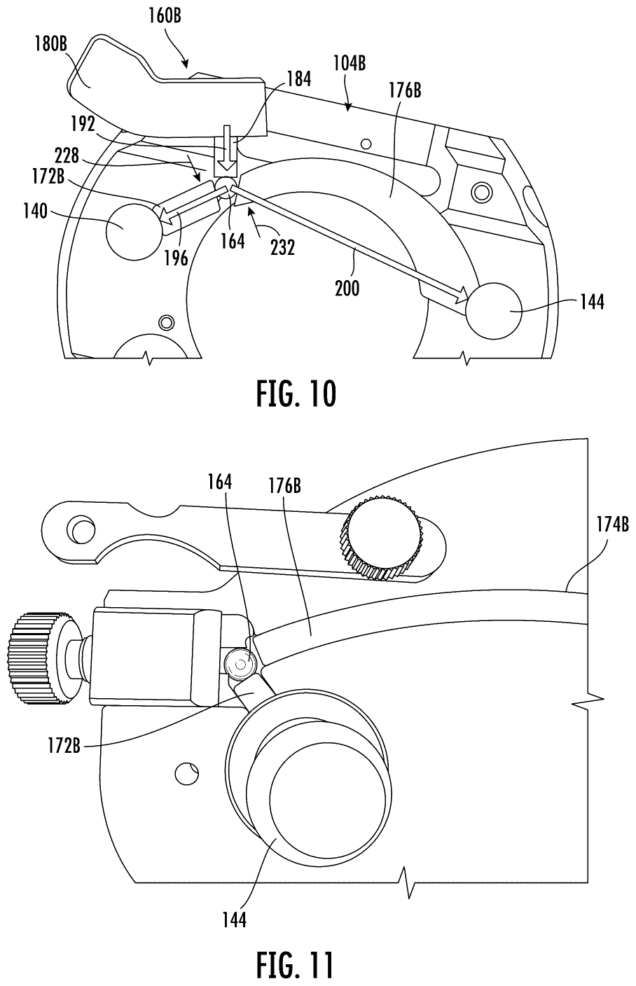

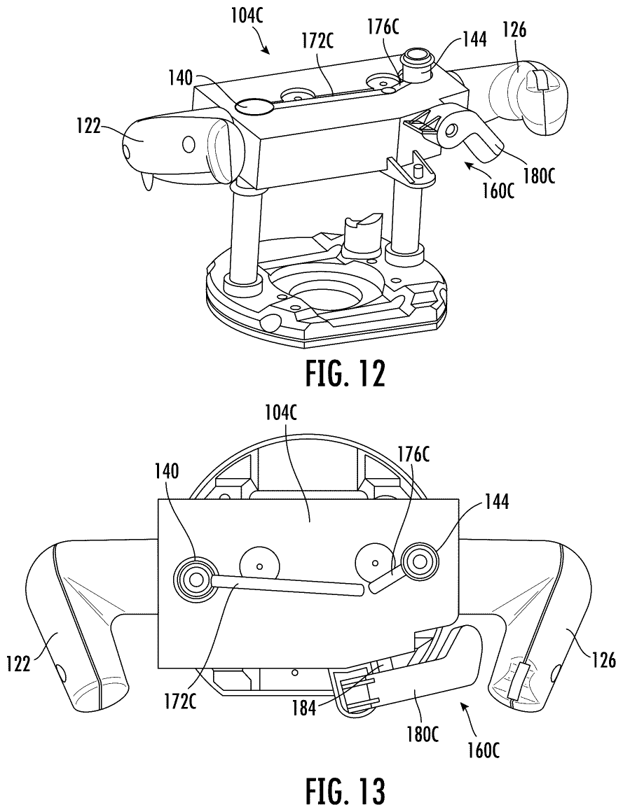

FIGS. 12 and 13 illustrate another embodiment of a clamping arrangement 104C similar to the embodiment of FIGS. 7-11. In the embodiment of FIGS. 12 and 13, similar to the embodiment described above, the actuator 160C is formed by a lever 180C connected to a threaded rod 184. As can be seen from FIG. 10, the lever 180C is adjacent to the grip region 126 such that the user can easily actuate the lever 180C without removing his or her hand from the grip region 126, facilitating easy setting and locking of the router at the desired height.

Additionally, the force transfer member 172C is longer than the force transfer member 176C in the embodiment of FIGS. 12 and 13, but both force transfer members 172C, 176C are formed as straight rods. The reader should appreciate, however, that one or both of the force transfer members 172C, 176C may be curved in the same manner as the force transfer member 172B described above.

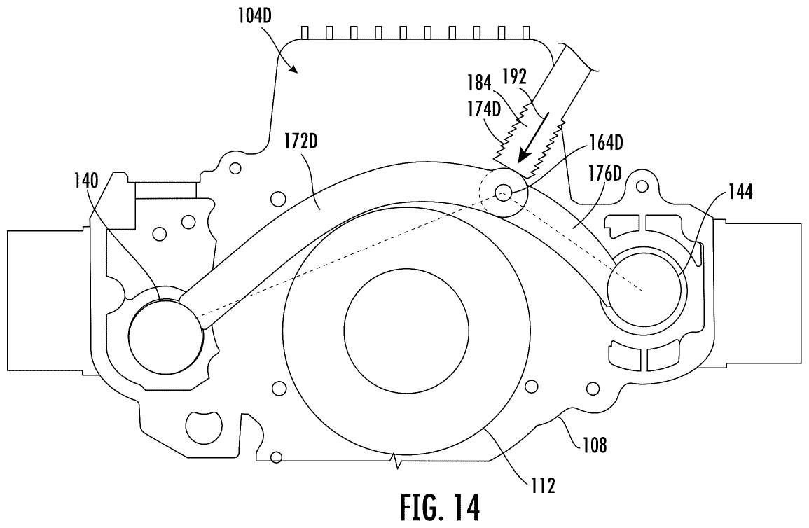

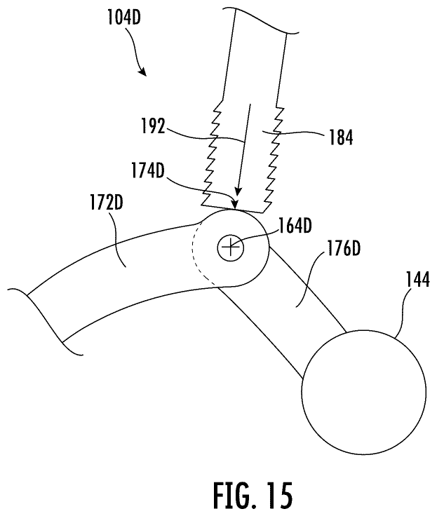

FIGS. 14 and 15 depict another embodiment of a clamping arrangement 104D configured similarly to the embodiment of FIGS. 7-11, except that the force transfer members are formed as linkages 172D, 176D connected to one another by a pin 164D. The threaded rod 184 of the actuator 160D engages a rounded end surface 174D of one or both of the linkages 172D, 176D so as to apply the actuator force 192 to the linkages 172D, 176D. The pin 164D is movable generally along the direction of application of the actuator force 192 such that, upon application of the actuator force 192, the pin-side ends of the linkages 172D, 176D also move along the direction of the actuator force 192. The linkages 172D, 176D have a fixed length, and therefore the movement of the pin ends of the linkages 172D, 176D causes the linkages 172D, 176D to exert outward clamping forces on the columns 140, 144, respectively, to clamp the columns 140, 144 in place.

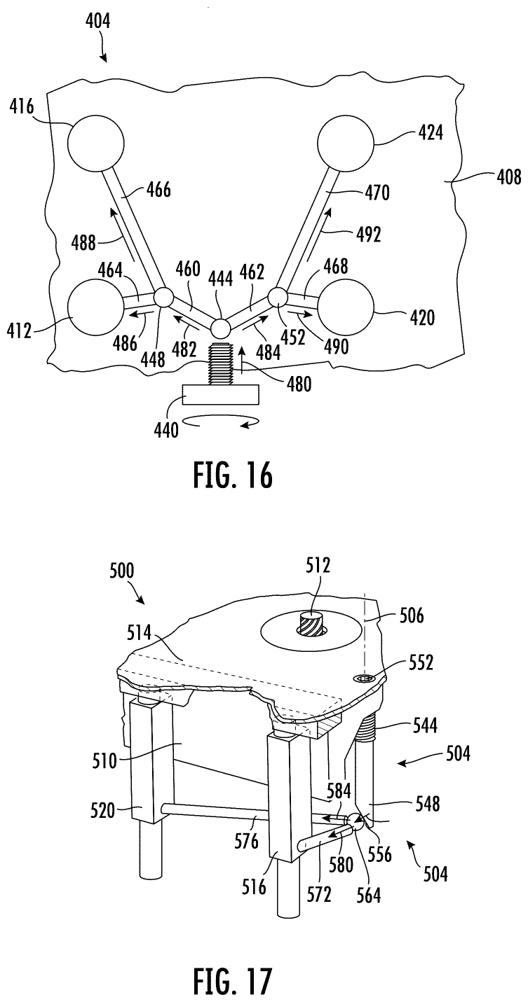

FIG. 16 is a schematic view of an embodiment of a clamping arrangement 404 for a power tool that is designed to clamp a carriage 408 to four columns 412, 416, 420, 424. The clamping arrangement 404 may be used in, for example, a large planer, an adjustable height table or work table, or any other structure with multiple columns and an adjustable carriage.

The clamping arrangement 404 includes an actuator 440, three force redirecting members, which are configured as balls 444, 448, 452 in the illustrated arrangement, and six force transfer members, which are configured as rods 460, 462, 464, 466, 468, 470. The clamping arrangement essentially functions as three clamping sub-arrangements configured similarly to the clamping arrangement discussed above with regard to FIG. 1.

Specifically, the actuator 440 is configured as threaded knob that can be actuated to exert a force 480 on the first ball 444. The first ball 444 redirects the actuator force 480 to the two rods 460, 462 as, respectively, intermediate forces 482 and 484. The rod 460 transmits the intermediate force 482 to the second ball 448, which redirects the intermediate force 482 to clamping forces 486 and 488 transmitted along the axes of rods 464 and 468, respectively. The rods 464, 468 impinge on the associated columns 412, 416, respectively, to lock the carriage 408 in place relative to the columns 412, 416.

Similarly, the intermediate force 484 acting along the rod 462 is redirected by the third ball 452 to the two rods 468, 470 as, respectively, clamping forces 490 and 492. The clamping forces 490, 492 exerted by the rods 468, 470 cause the rods 468, 470 to impinge on the columns 420, 424, locking the carriage 408 to the columns 420, 424. As a result, the clamping arrangement 404 provides a simple and reliable mechanism for clamping the carriage 408 to four columns 412, 416, 420, 424 by actuating only a single actuator 440, without the need for tight tolerances or complex mechanisms.

Additionally, the reader should appreciate that the clamping arrangements disclosed herein are not limited for use to two or four columns. Rather, the clamping arrangement may include any suitable number of nested clamping sub-arrangements to actuate the desired number of columns. For example, while the embodiment of FIG. 16 depicts three clamping sub-arrangements, in other embodiments, the clamping arrangement may include two clamping sub-arrangements to clamp to three columns, four clamping sub-arrangements to clamp to five columns, etc.

FIG. 17 depicts another configuration of a clamping arrangement 504 in which the input axis 506 about which the actuator rotates is not in the plane defined by the force transfer members 572, 576. The clamping arrangement 504 may be used, for example, in a router lift 500 to adjust the height of a router carriage 510, on which the router bit 512 is supported, relative to the tabletop 508 by clamping to two or more columns 516, 520.

The clamping arrangement 504 includes an actuator 540 having a rotatable input portion 544 configured as a threaded rod, and a rotationally-fixed output portion 548. The input portion 544 has an input receiver 552, for example a hexagonal opening configured to receive an output shaft of a removable knob (not shown) so as to rotate with the removable knob. The input portion 544 is threaded into a threaded opening that passes through the table top 514 such that rotation of the input portion 544 is converted into vertical motion along the axis of the input portion 544. The vertical movement of the input portion 544 acts on the output portion 548, which is rotationally fixed but vertically movable relative to the table top 514.

The output portion 548 of the actuator 540 has a wedge-shaped region at the end opposite the input portion 544 that includes an angled surface 556. The angled surface 556 converts the vertical movement of the output portion 548 into a force 560 acting against the force redirecting member 564, which is configured as a ball, at least partially in the horizontal plane. Although not illustrated in FIG. 17, the force redirecting member 564 is restrained from movement in the vertical direction, and therefore the force 560 acting against the force redirecting member 564 is redirected along the horizontal plane.

In a manner similar to the embodiment discussed above with regard to FIG. 1, the force redirecting member 564 redirects the actuator force 560 along two force transfer members 572, 576 as, respectively, clamping forces 580 and 584. The force transfer members 572, 576 impinge on the respective columns 516, 520, which are connected to the router lift 510. As a result, the forces 580, 584 act to clamp the columns 516, 520 in place relative to the table top 514.

The reader should appreciate that the features disclosed above in the embodiments of FIGS. 1-16 may also be used in the embodiment of FIG. 17. For example, one or both of the force transfer members 572, 576 may be curved around obstructions. Additionally or alternatively, the clamping arrangement 504 may include more than one clamping sub-arrangement so as to clamp more than two columns.

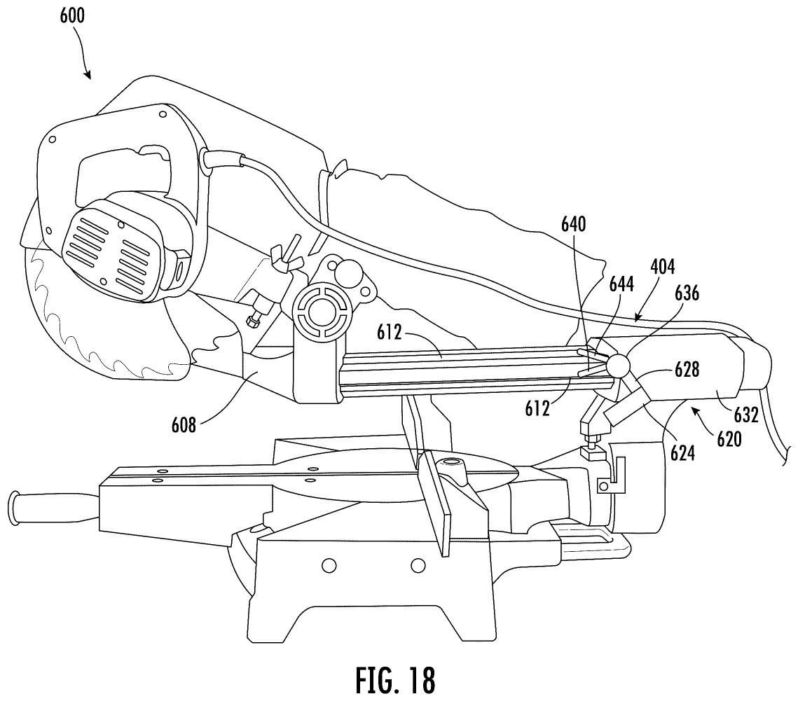

FIG. 18 depicts another clamping arrangement 604 used in a sliding tabletop saw 600, for example a miter saw, to lock a saw carriage 608 to two slide tubes 612. In particular, the clamping arrangement 604 includes an actuator 620, which includes a lever 624 connected to a threaded rod 628 that is threaded into a hole in the bevel post 632. The threaded rod 632 is configured to, in the clamped state, impinge on the force redirecting member 636, which redirects the actuator force of the threaded rod 628 along the axes of two force transfer members 640, 644. Each of the force transfer members 640, 644 impinges on a respective one of the slide tubes 612 so as to lock the bevel post 632 to the slide tubes 612 and fix the position of the saw carriage 608 along the axis of the slide tubes 612.

It will be appreciated that variants of the above-described and other features and functions, or alternatives thereof, may be desirably combined into many other different systems, applications or methods. Various presently unforeseen or unanticipated alternatives, modifications, variations or improvements may be subsequently made by those skilled in the art that are also intended to be encompassed by the foregoing disclosure.

1. A power tool comprising:
at least two columns;
a carriage configured to move along the at least two columns; and
a clamping arrangement configured to selectively clamp the carriage to at least a first column and a second column of the at least two columns, the clamping arrangement comprising:
an actuator configured to be actuated to move the clamping arrangement between a clamped state and an unclamped state; and
a force redirecting member,
wherein, in the clamped state, the actuator acts on the force redirecting member with an actuator force in a first direction, and the force redirecting member redirects the actuator force into a first clamping force acting on the first column in a second direction and a second clamping force acting on the second column in a third direction.

2. The power tool of claim 1, the clamping arrangement further comprising:
a first force transfer member acted on by the force redirecting member in the clamping state to transfer the first clamping force to the first column; and
a second force transfer member acted on by the force redirecting member in the clamping state to transfer the second clamping force to the second column.

3. The power tool of claim 2, wherein:
the first clamping force acts along a first line of action from the force redirecting member to the first column,
second clamping force acts along a second line of action from the force redirecting member to the second column, and
the first and second lines of action are nonparallel.

4. The power tool of claim 3, wherein a first length of the first line of action is greater than a second length of the second line of action.

5. The power tool of claim 4, wherein the first force transfer member includes an elongated curved member extending from the force redirecting member to the first column.

6. The power tool of claim 5, further comprising:
a motor through which the first line of action extends.

7. The power tool of claim 6, wherein the carriage includes a channel that is complementary to the elongated curved member and in which the elongated curved member is constrained.

8. The power tool of claim 2, wherein the force redirecting member has an at least partially round surface, each of the respective first and second lines of action extends from a point of contact between the respective first and second force transfer member and the at least partially round surface of the force redirecting member.

9. The power tool of claim 8, wherein the force redirecting member is spherical or cylindrical.

10. The power tool of claim 2, wherein:
the actuator rotates to move the clamping arrangement between the clamped and unclamped states about an actuator axis, and the first and second force transfer members define a plane.

11. The power tool of claim 10, wherein the plane is substantially perpendicular to the actuator axis.

12. The power tool of claim 1, wherein the actuator includes a threaded rod that is threaded through a threaded opening in the carriage and configured such that, when the actuator is rotated to move the clamping arrangement from the unclamped state to the clamped state, the threaded rod exerts the actuator force on the force redirecting member.

13. The power tool of claim 1, wherein:
the at least two columns includes a third column, and
the clamping arrangement further comprises a second force redirecting member that redirects the first clamping force into a third clamping force acting on the first column and a fourth clamping force acting on the third column.

14. A clamping arrangement comprising:
an actuator configured to be actuated to move the clamping arrangement between a clamped state, in which the clamping arrangement clamps to at least a first column and a second column, and an unclamped state; and
a force redirecting member,
wherein, in the clamped state, the actuator acts on the force redirecting member with an actuator force in a first direction, and the force redirecting member redirects the actuator force into a first clamping force acting on the first column in a second direction and a second clamping force acting on the second column in a third direction.

15. The clamping arrangement of claim 14, further comprising:
a first force transfer member acted on by the force redirecting member in the clamping state to transfer the first clamping force to the first column; and
a second force transfer member acted on by the force redirecting member in the clamping state to transfer the second clamping force to the second column.

16. The clamping arrangement of claim 15, wherein:
the first clamping force acts along a first line of action from the force redirecting member to the first column,
second clamping force acts along a second line of action from the force redirecting member to the second column, and
the first and second lines of action are nonparallel.

17. The clamping arrangement of claim 16, wherein a first length of the first line of action is greater than a second length of the second line of action.

18. The clamping arrangement of claim 17, wherein the first force transfer member includes an elongated curved member extending from the force redirecting member to the first column.

19. The clamping arrangement of claim 18, wherein the elongated curved member is constrained in a channel that is complementary to the elongated curved member.

20. The clamping arrangement of claim 15, wherein the force redirecting member has an at least partially round surface, each of the respective first and second lines of action extends from a point of contact between the respective first and second force transfer member and the at least partially round surface of the force redirecting member.
